(19) United States
(12) Patent Application Publication
(10) Pub. No.: US 2014/0208892 A1
(43) Pub. Date: Jul. 31, 2014

(54) BREATHER SYSTEM FOR AN INTERNAL COMBUSTION ENGINE

(71) Applicant: TRIUMPH DESIGNS LIMITED, Leicestershire (GB)

(72) Inventors: Robert Morrison, Leicestershire (GB); Benjamin Ady, Leicestershire (GB)

(73) Assignee: TRIUMPH DESIGNS LIMITED, Leicestershire (GB)

(21) Appl. No.: 13/752,625

(22) Filed: Jan. 29, 2013

(51) Int. Cl. F16H 57/027

(52) U.S. Cl. CPC F16H 57/027
USPC 74/606 R

(57) ABSTRACT

A breather system of an internal combustion engine suitable for use on a motorcycle. A gearbox has a housing (12) forming a gearbox cavity (20) in which a gear selector drum (30) is provided. The selector drum (30) has an elongate hollow structure and has an outlet opening (44) at or adjacent a first end. The selector drum (30) is provided with at least one inlet (46) hole provided in a sidewall thereof, within the gearbox cavity (20), such that a breather flow path extends from the inlet (46) to the outlet opening (44).

### SUMMARY OF THE INVENTION

This invention relates to breather systems for internal combustion (IC) engines.

### BACKGROUND TO THE INVENTION

Inside an engine internal pressure is produced within the crankcase. This pressure is generally caused by a small leakage of combustion gasses past the piston rings, which is known as blow-by. If this pressure is not released, the subsequent build up can cause gaskets and seals to fail, creating engine oil leaks.

Breather systems to alleviate this are commonplace in internal combustion engines and commonly include a labyrinth type passage way to separate oil from vented gas. As there is typically oil present within the internal structures of IC engines and their associated gearboxes etc, it is common for oil droplets to become entrained into the breather gas. The labyrinth passageways, which comprise a plurality of bends, separates oil droplets that are entrained within the air flow and prevents them from being drawn back into the combustion chambers of the engine as part of the positive crankcase ventilation system. If lubricant oil from the crankcase housing were to be drawn back into the combustion chambers(s) this would have a negative effect and is therefore undesirable.

Currently the labyrinth passageways are located in a number of different places dependant upon the design, but may be in the cam cover, crankcase, clutch chamber, airbox, or other location, The inlet into the labyrinth may be at a remote location so as to draw in the blow-by gasses.

Although the existing labyrinth passageways enable separation of oil entrained in the gasses there remains space for improvement of existing solutions.

### OBJECT OF THE INVENTION

The object of the present invention is a breather system for an IC engine, and a gearbox incorporating that breather system, that is simple in structure, requires only a minimal change, if any, of the number of parts, and which reduces the speed of gasses at the inlet to the breather system.

According to one aspect of the invention a breather system for an internal combustion engine is provided. The breather system includes a gearbox having a gearbox housing forming a gearbox cavity. The gearbox cavity having a selector drum therein, movement of which mechanically moves gears within the gearbox so as to shift from one gear to another gear. The selector drum has an elongate hollow structure having an outlet opening at or adjacent a first end, and at least one inlet hole provided in a sidewall thereof within the gearbox cavity. In this manner a breather flow path is provided which extends from the at least one inlet to said outlet opening.

According to another aspect of the invention there is provided a gearbox for an internal combustion engine powered motor vehicle. The gearbox includes a gearbox housing forming a gearbox cavity. Arranged within the gearbox cavity are a plurality of gears and a selector drum. The selector drum has an elongate hollow structure with an outlet opening at or adjacent a first end thereof, and at least one inlet hole provided therein, within the gearbox cavity. In this manner a breather flow path is defined internally of said selector drum extending between said at least one inlet and said outlet opening.

According to a further aspect of the invention there is provided a motor vehicle. The vehicle includes an internal combustion engine, a gearbox having a gearbox housing forming a gearbox cavity, a selector drum within the gearbox cavity, and a breather flow path. The selector drum has an elongate hollow structure which has an outlet opening at or adjacent a first end thereof and at least one inlet hole provided in a sidewall thereof within the gearbox cavity such that the breather flow path extends inside the selector drum from the at least one inlet to the outlet opening.

In all the aspects of the invention a plurality of inlet holes may be provided along the length of the selector drum. Providing plurality of inlet holes decreases the inlet velocity at any one of said holes for any particular airflow, thus reducing the amount of oil that is entrained within the blow-by gases entering the breather flow path.

### BRIEF INTRODUCTION TO THE DRAWINGS

A preferred embodiment is described below, by way of example only, with reference to the accompanying drawings in which:

FIG. 1 is a side view of a motorcycle in accordance with the present invention;

FIG. 2 is a side view of a crankcase incorporating a gear box of the present invention;

FIG. 3 is a sectional view on line “X”-“X” of FIG. 2;

FIG. 4 shows an enlarged detail of the selector drum and gear arrangement of FIG. 3, with some detail removed for clarity;

FIG. 5 shows a cross section through a selector drum for use in the present invention;

FIG. 6 shows a perspective view through a selector drum for use in the present invention;

FIG. 7 shows a close up of the labyrinth detail of FIG. 2 with some detail omitted for clarity;

FIG. 8 shows a perspective view of FIG. 7;

FIG. 9 shows a top view of the housing; and

FIG. 10 shoes the view of FIG. 9 with the second labyrinth chamber cover on.

### DETAILED DESCRIPTION OF THE PREFERRED EMBODIMENTS

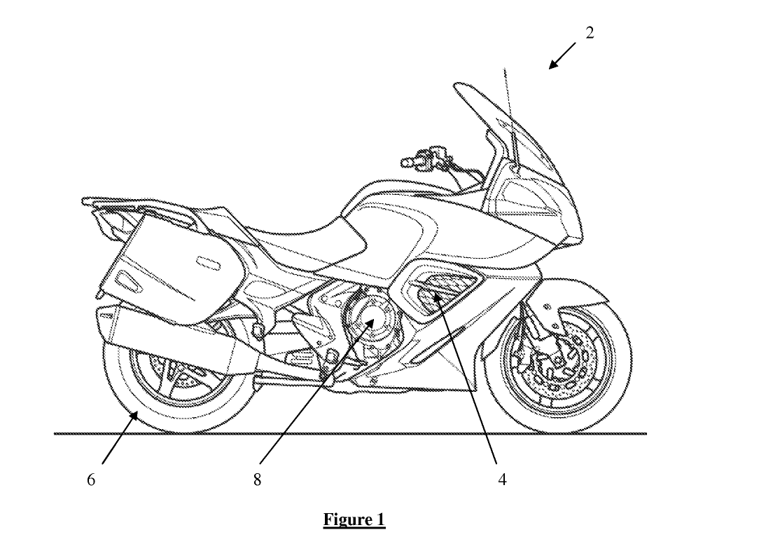

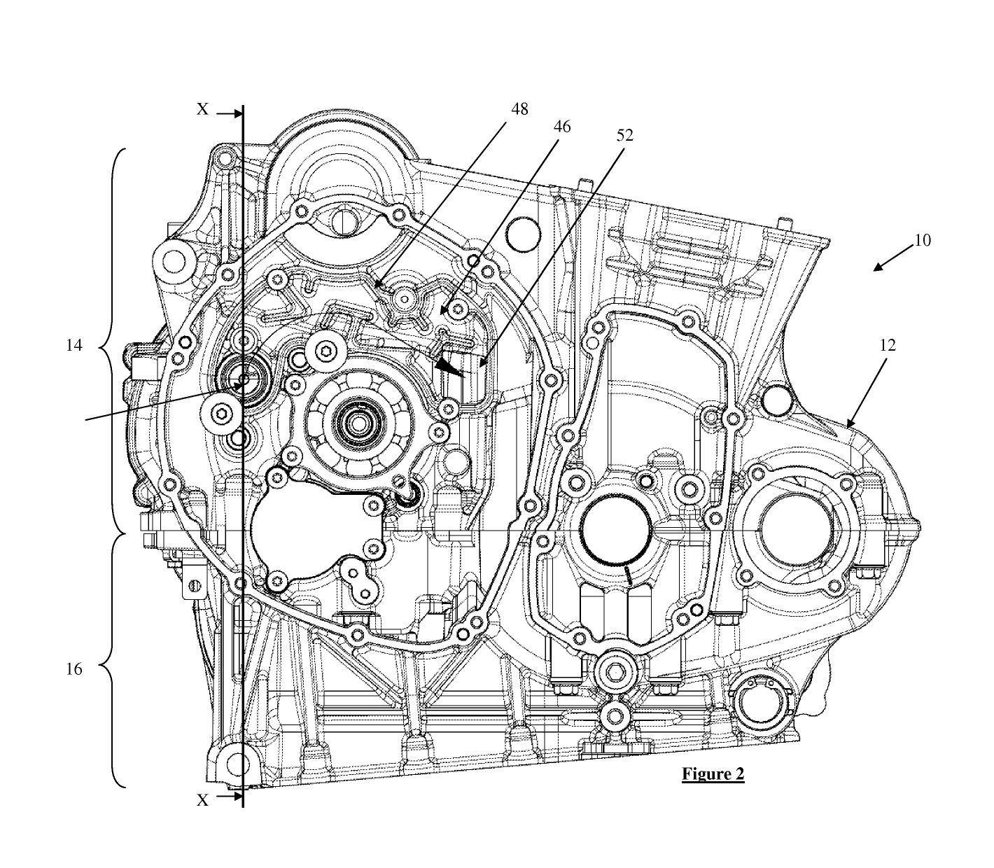

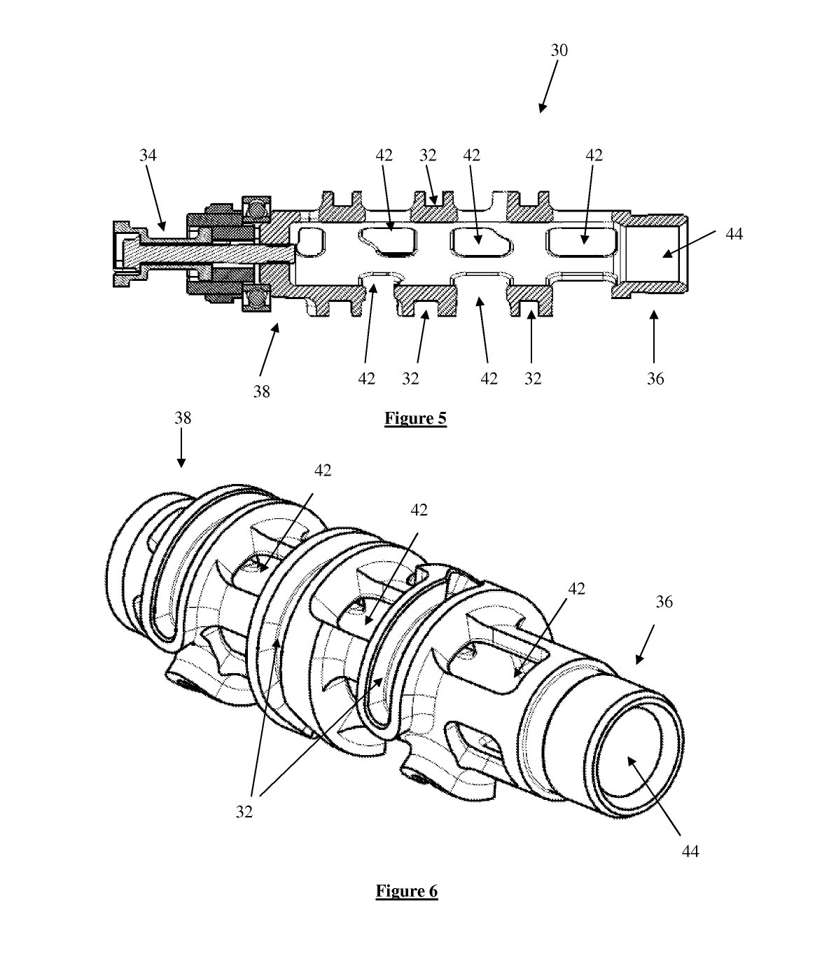

With initial reference to FIG. 1 a motorcycle 2 is shown which includes an internal combustion engine 4 that provides drive to the rear wheel 6 of the motorcycle via a gearbox 8 and clutch arrangement. The gearbox is formed integrally as part of the engine crankcase. The gearbox includes a breather system of the invention. The gearbox 8 and the breather system are described in greater detail below with reference to FIGS. 2 to 5. Although described with reference to a motorcycle the gearbox and breather system described herein may be used in combination with other vehicles having an IC engine without departing from the scope of the invention.

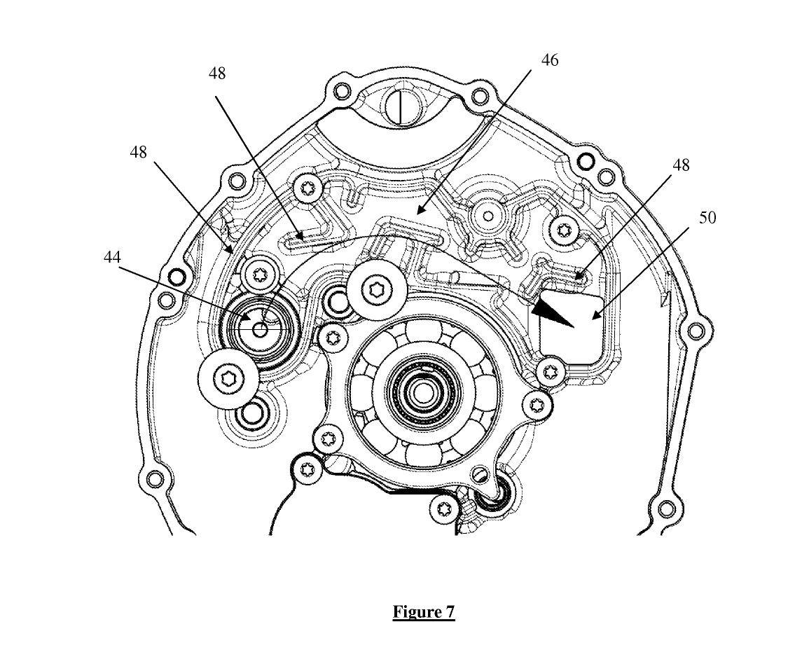

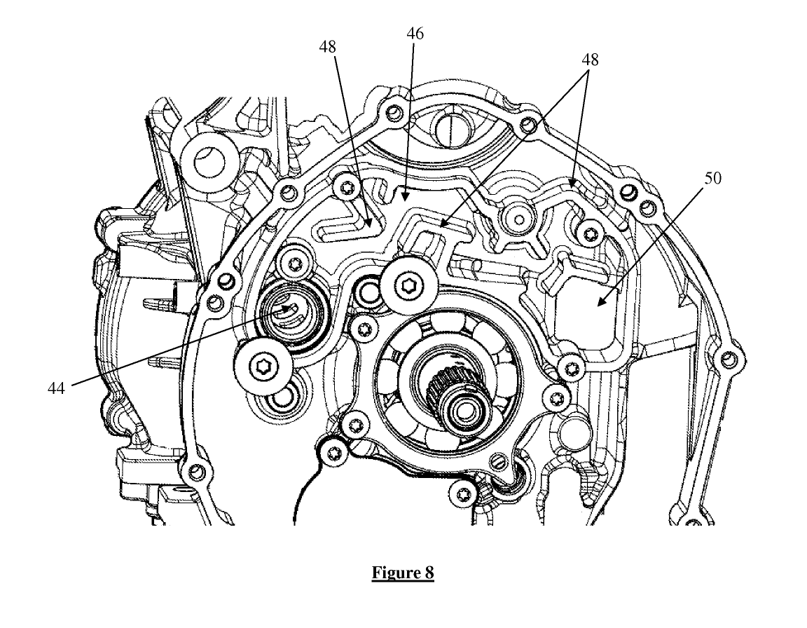

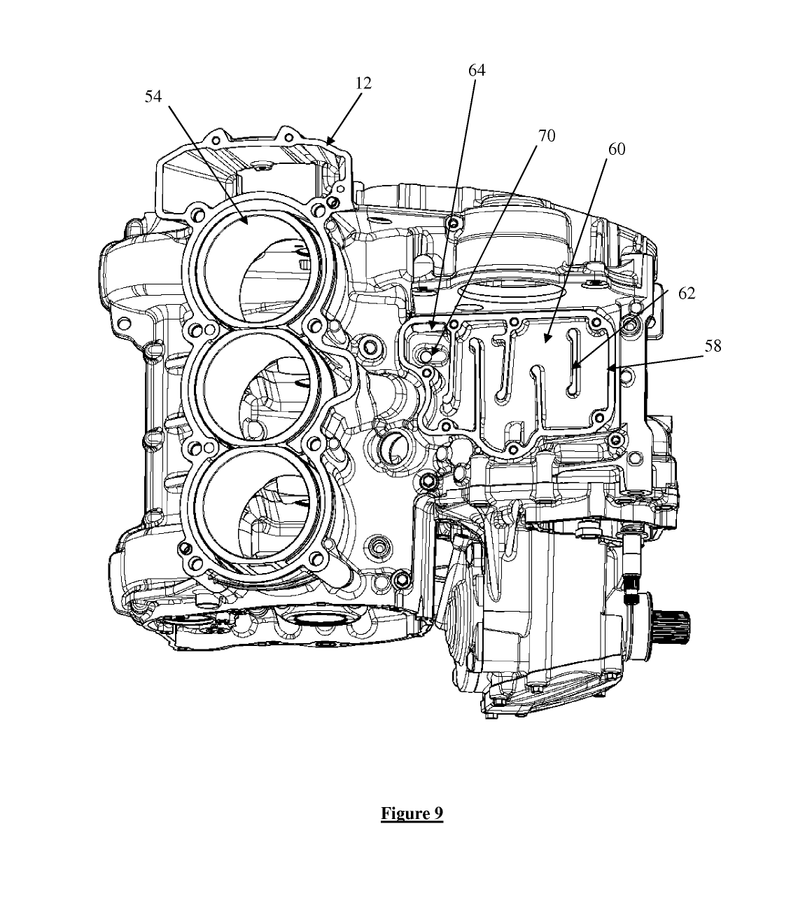

With reference to FIGS. 2 to 8 a combined crankcase and gearbox 10 is provided. The combined crankcase and gearbox 10 has a housing 12, which may comprise a cast or machined metal housing which forms an internal gearbox cavity 20 in which the gears 22 etc. are housed. As shown the housing 12 comprises an upper 14 and a lower 16 section which are bolted together with bolts 18. As will be appreciated a seal, gasket or sealant will usually be provided between the upper and lower section.

As described above the gearbox and crankcase are an integral component and the gearbox cavity is in fluid communication with the crank side of the pistons of the IC engine. In this manner, when the engine is running, blow-by gasses, which escape the piston from the engine piston chamber of the engine 4 to the crankcase housing 12, can pass into the gearbox cavity 20. Although the gearbox 8 is described herein as integral with the crankcase in the described embodiment, it will be appreciated that the crankcase and the gearbox may be separate components, for example separate castings, that are assembled together in a manner such that there is fluid communication between them, and such arrangements are within the scope of the invention.

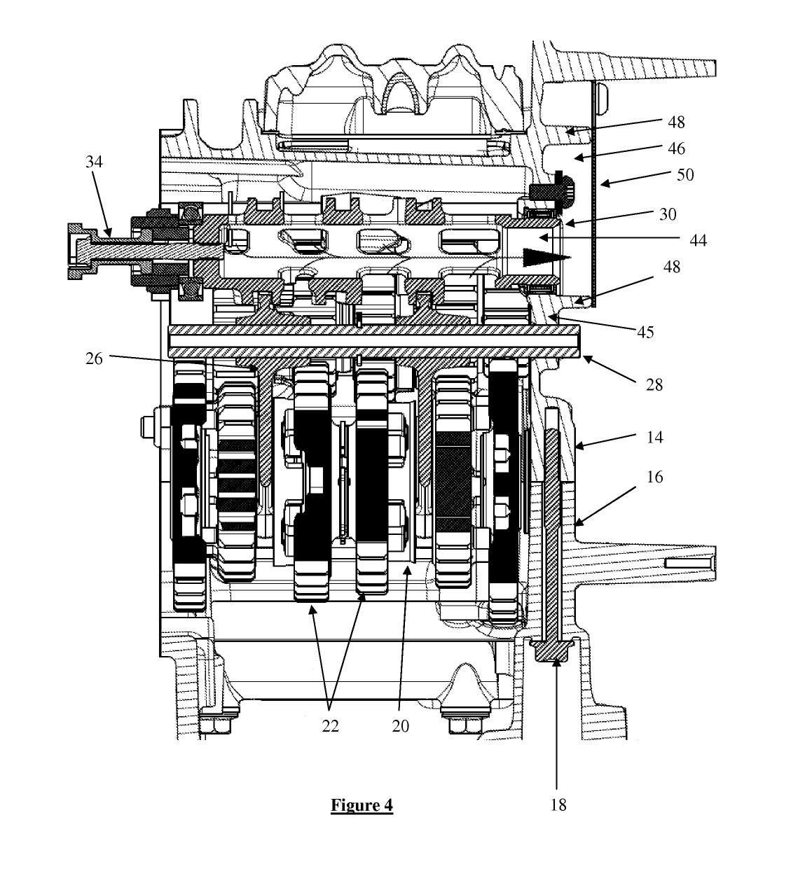

Within the gearbox cavity 20 are provided a plurality of gears 22 which can be moved into and out of engagement to control the gear ratio. In order to move the gears 20 within the gearbox cavity there are provided shifter plates 26 which are slideably movable of a guide rod 28. Movement of the shifter plates 26 in a sideways direction (FIG. 4) bears upon the gears 22 to move them into and out of engagement. In order to move the shifter plates 26 a selector drum 30 is provided.

The selector drum 30 has a plurality of surface features in the form of cam tracks 32 disposed on and extending radially from its outer surface. The cam tracks 32 engage with the shifter plates 26 such that as the shifter drum 30 rotates about its longitudinal axis the cam tracks move the shifter plates 26 on the guide rod 28 to change gear.

The selector drum 30 has a selector drum drive 34 attached to one end thereof by which drive 34 the selector drum may be rotated. The drive may be driven by a mechanical or electro-mechanical mechanism as known in the art.

The selector drum 30 has an elongate hollow structure which is open at a first end and closed at a second end 38. As can be seen the second end is closed by a bolt 40 which forms part of the selector drum drive 34, attaching it to the selector drum 30. A plurality of openings 42 are provided in the side walls of the selector drum 30 and are positioned between the cam tacks 32. The selector drum 30 thereby defines a breather flow path for blow-by gasses within the gearbox cavity 20 such that the gasses can enter the selector drum 30 via inlet openings 42, and exit the selector drum 30 via an outlet opening 44 in the first end.

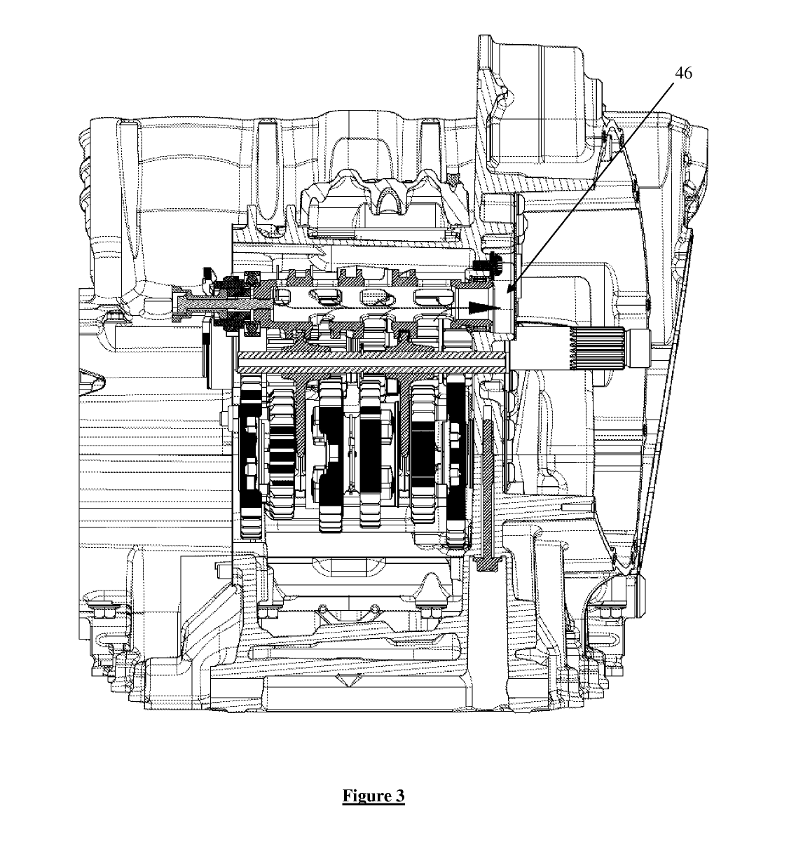

As can be seen in FIGS. 3 and 4 the first end 36 of the selector drum 30 extends through a sidewall 45 of the combined crankcase and gearbox housing 12 such that blow-by gases passing therethrough can pass through the outlet opening 44 out of the gearbox cavity 20. The outlet opening 44 opens into a labyrinth cavity 46 which is defined between a plurality of ribs 28 and a labyrinth cavity cover 50 (omitted in FIG. 2 for clarity). Blow-by gasses pass into the labyrinth cavity 46 via the selector drum 30, and pass around the various webs 48 which define a plurality of turns in the flow path direction which result in oil entrained in the gases from separating out. The gasses then exit the labyrinth cavity through opening 52 which opens into a pathway through the crankcase.

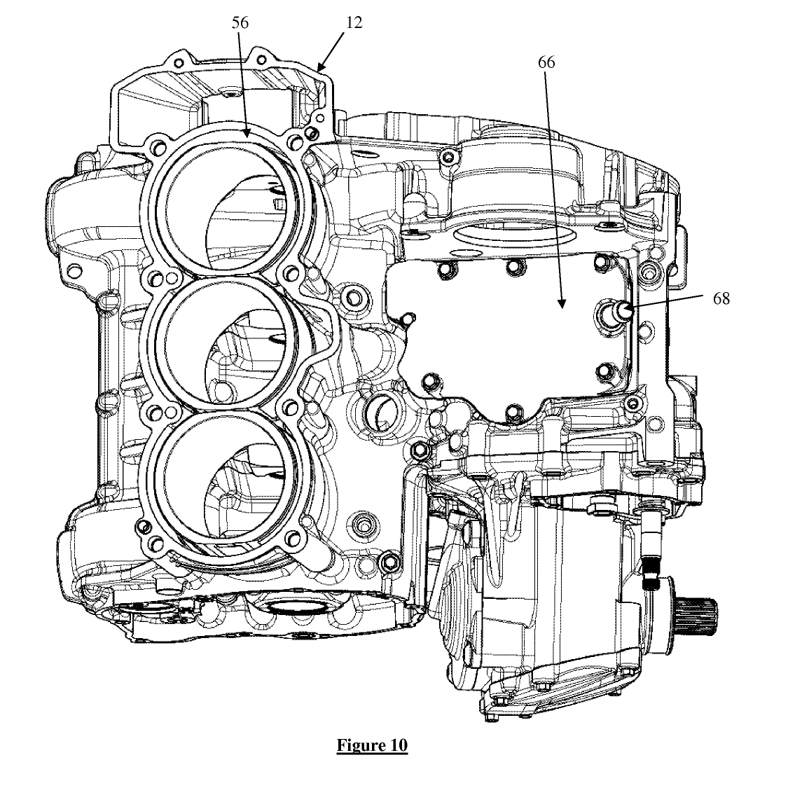

Referring now to FIGS. 9 and 10 a top view of the housing 12 is shown. The housing 12 also defines a lower portion of the piston cylinders 56 of the engine, and a second labyrinth chamber 58 in which a labyrinth pathway 60 is formed between a plurality of webs 62 that extend therefrom. The gasses passing through the outlet 52 from the first labyrinth chamber enter into the second labyrinth chamber 58 via second labyrinth chamber inlet 64. A cover 66 encloses the second labyrinth chamber 58, and has a breather gas outlet 68 therein, from which gas exiting can be transferred (via a conduit or other suitable pathway) to the airbox to be recirculated back into the combustion chamber(s) of the engine.

An oil drain 70 is provided in the second labyrinth chamber 58 from which separated oil can drain back to an oil sump of the engine.

As will be understood the structure described above provides an alternative to current designs for a breather system for an IC engine which vents blow-by gasses from the crankcase housing via a selector drum within the gearbox. The design vents gas directly from the gearbox and the design enables for a large surface area for the inlet to the breather passageway. This reduces inlet gas velocity which assists in reducing the amount of entrained oil within the blow-by gasses being vented.

Furthermore there is a benefit to having the entrance to the labyrinth passageway in the gearbox when the labyrinth is in the clutch cavity, as opposed to placing both in the clutch cavity. In the clutch cavity there is a greater tendency for the oil therein to produce an oil foam. If this gets drawn into the inlet to the labyrinth passageway the foam simply gets pumped through the breather system. The foam is created, for example, by such things as the oil being flung from the crank at high speed and from the oil pump drive chain and sprocket which is often positioned behind, and driven from, the clutch.

Although there is oil mist in the gearbox cavity there tends to be less aerated foam. These reasons do depend on engine architecture but are particularly common in motorcycle engines.

As will be appreciated from the above description the inlet openings in the selector drum are radial and the flow path through the selector drum is axial. This provides the advantage of causing a gas direction change immediately after the entry points. The gas enters the drum radially and then immediately has to change direction to travel axially along the drum. This assists in separating large oil droplets.

The increased benefits of enabling the selector drum itself, through virtue of its low gas entry speed and initial 90 degree turns can assist in enabling a reduced labyrinth volume which therefore provides a space and packaging advantage.

The above description is presented for exemplary purposes only. This description is not meant to limit the scope of protection insofar as it is understood that certain departures may be taken form the above-described embodiment without departing from the overall spirit and scope of the invention.

1. A breather system for an internal combustion engine, the breather system comprising:
a gearbox having a housing forming a gearbox cavity, said gearbox cavity having a selector drum therein; wherein
said selector drum has an elongate hollow structure having an outlet opening at or adjacent a first end; and
said selector drum is provided with at least one inlet hole provided in a sidewall thereof, within the gearbox cavity, such that a breather flow path extends from said at least one inlet to said outlet opening.

2. The breather system according to claim 1 wherein the selector drum is provided with a plurality of inlet holes therein.

3. The breather system according to claim 1 wherein said selector drum has one or more surface features thereon configured to transmit movement of said selector drum in a rotational or axial direction to at least one gear.

4. The breather system according to claim 3 further comprising a plurality of shifter plates slideably mounted on at least one guide rod and wherein said surface features of said selector drum are configured to move said at least one shifter plates on said guide rod.

5. The breather system according to claim 3 wherein said surface features comprise a plurality of cam tracks which extend radially from said selector drum

6. The breather system according to claim 5 wherein each of said cam tracks is configured to engage with a different shifter plate within said gearbox.

7. The breather system of claim 6 wherein said at least one inlet hole is provided between said cam tracks.

8. The breather system of claim 7 wherein said the selector drum is provided with a plurality of inlet holes therein and wherein each of said plurality of inlet holes are provided between said cam tracks.

9. The breather system of claim 1 wherein said first end of said selector drum extends into an opening in least one sidewall of said gearbox cavity to create a flow path between the interior of the gearbox cavity and the exterior of the gearbox cavity.

10. The breather system according to claim 9 wherein said first end of said selector drum extends through said opening in said least one sidewall of said gearbox cavity.

11. The breather system according to claim 9 wherein the selector drum extends between two openings located on opposite side walls of said gearbox cavity.

12. The breather system according to claim 11 wherein the said second end of said selector drum in mounted in said opening via a rotating seal.

13. The breather system according to claim 1 wherein said selector drum outlet opening comprises an axial opening in one end of said selector drum.

14. The breather system according to claim 1 wherein a second end of said selector drum is attached to a selector drum drive external to said gearbox cavity through one of said openings so as to close said opening.

15. The breather system of claim 1 wherein said outlet opening opens into a first labyrinth cavity.

16. The breather system of claim 15 wherein said first labyrinth cavity is formed between at least one web extending externally from a side wall of said gearbox cavity, and a first labyrinth cavity cover attached to said housing, and defines a labyrinth passageway between the outlet opening and a first labyrinth cavity outlet.

17. The breather system of claim 15 wherein said first labyrinth cavity is formed between an external side wall of said housing and at least one web extending from a first labyrinth cavity cover towards the gearbox, and defines a labyrinth passageway between the outlet opening and a first labyrinth cavity outlet.

18. The breather system of claim 1 wherein the housing comprises a combined crankcase and gearbox housing.

19. The breather system of claim 1 further comprising a second labyrinth cavity comprising: an second labyrinth cavity inlet in fluid communication with the first labyrinth cavity outlet, a breather gas outlet, and a plurality of webs therebetween defining a labyrinthine flow path between the second labyrinth cavity and said breather gas outlet.

20. A gearbox for an internal combustion engine powered motor vehicle; the gearbox comprising:
a gearbox housing forming a gearbox cavity;
a plurality of gears; and
a selector drum located in said gearbox cavity; wherein
said selector drum has an elongate hollow structure with an outlet opening at or adjacent a first end thereof; and
said selector drum has at least one inlet hole provided therein within the gearbox cavity; such that
a breather flow path is defined internally of said selector drum extending between said at least one inlet and said outlet opening.

21. The gearbox according to claim 20 further comprising:
a plurality of shifter plates slideably mounted on at least one guide rod and wherein
said selector drum has a plurality of selector cam tracks extending radially therefrom, each said selector plate received in one of said cam tracks such that rotation of said selector drum moves said shifter plates on said guide rod such that and wherein said shifter plates moves said gears; and wherein
said selector drum is provided with a plurality of inlet holes therein and wherein said plurality of inlet holes are provided between said cam tracks.

22. The gearbox of claim 20 wherein the gearbox has an opening in least one sidewall of said gearbox cavity, and wherein said first end of said selector drum extends into an opening to create a flow path between the interior of the gearbox cavity and the exterior of the gearbox cavity.

23. The gearbox of claim 20 wherein said selector drum outlet opening opens into a labyrinth cavity formed between at least a first web extending from an external side wall of said gearbox housing and a labyrinth cavity cover attached to said gearbox.

24. A vehicle comprising:
an internal combustion engine;
a gearbox having a gearbox housing forming a gearbox cavity, said gearbox cavity having a selector drum therein; and
a breather flow path; wherein
said selector drum comprises an elongate hollow structure which has an outlet opening at or adjacent a first end thereof;
said selector drum is provided with at least one inlet hole provided in a sidewall thereof within the gearbox cavity; and
said breather flow path extends inside said selector drum from said at least one inlet to said outlet opening.

25. The vehicle according to claim 24 wherein said vehicle comprises a motorcycle.
